(19) United States
(12) Patent Application Publication
(10) Pub. No.: US 2026/0128862 A1
(43) Pub. Date: May 7, 2026

(54) SYSTEMS AND METHODS FOR DATA INTEGRITY VERIFICATION OF MESSAGES FOR VEHICLE MARSHALING

(71) Applicant: Ford Global Technologies, LLC, Dearborn, MI (US)

(72) Inventors: Krishna Bandi, Novi, MI (US); Vyas Darshan Shenoy, Canton, MI (US); Mario Anthony Santillo, Canton, MI (US)

(73) Assignee: Ford Global Technologies, LLC, Dearborn, MI (US)

(21) Appl. No.: 18/936,291

(22) Filed: Nov. 4, 2024

(51) Int. Cl. H04L 9/08

(52) U.S. Cl. CPC H04L 9/0825

(57) ABSTRACT

A method includes the calculation of a first checksum value, the transmission of one or more infrastructure marshaling messages that includes a second checksum value based on the first checksum value, the receipt of one or more vehicle marshaling messages, and the verification of the one or more vehicle marshaling messages.

### FIELD

The present disclosure relates to the computation and verification of data integrity associated with an exchange of one or more messages.

### BACKGROUND

The statements in this section merely provide background information related to the present disclosure and may not constitute prior art.

Prior to autonomous control of an automated vehicle, one or more messages are typically exchanged between the automated vehicle and a central server. The exchange of the message(s) can allow for threat(s) if not properly secured. For example, data integrity of the message(s) can be compromised. Additional threats can include a lack of a synchronized process to check whether each data bit has been received by an intended recipient, and a lack of a functional approach to compute and/or verify a payload associated with the message(s).

The present disclosure addresses these and other issues related to the protection of data integrity of exchanged messages in a vehicle marshaling system.

### SUMMARY

This section provides a general summary of the disclosure and is not a comprehensive disclosure of its full scope or all of its features.

The present disclosure provides a method for initiating autonomous control of an automated vehicle, the method comprising: calculating, by one or more processors of an infrastructure system, a first checksum value based on an infrastructure-side secret key and encoded data associated with the automated vehicle located within a distance-related threshold from the infrastructure system; transmitting, to the automated vehicle, one or more infrastructure marshaling messages that includes a second checksum value based on the first checksum value; receiving, from the automated vehicle, one or more vehicle marshaling messages that includes a third checksum value based on a vehicle-side secret key in response to the automated vehicle verifying the one or more infrastructure marshaling messages; and verifying the one or more vehicle marshaling messages, wherein the verification of the one or more vehicle marshaling messages includes: decoding the one or more vehicle marshaling messages, calculating a fourth checksum value based on the vehicle-side secret key in response to decoding the one or more vehicle marshaling messages, and determining whether the fourth checksum value corresponds to the third checksum value; wherein the calculation of the first checksum value further comprises: transforming the infrastructure-side secret key by a transformation constant; and appending the transformed infrastructure-side secret key to the encoded data associated with the automated vehicle; further comprising: calculating the second checksum value based on a transformation constant; wherein the one or more infrastructure marshaling messages further includes the encoded data associated with the automated vehicle, a data length associated with the one or more infrastructure marshaling messages, or a combination thereof; wherein the one or more vehicle marshaling messages further includes the encoded data associated with the automated vehicle, a data length associated with the one or more vehicle marshaling messages, or a combination thereof; wherein decoding the one or more vehicle marshaling messages further comprises: decoding the third checksum value; decoding a data length associated with the one or more vehicle marshaling messages; and decoding the encoded data associated with the automated vehicle; wherein the verification of the one or more vehicle marshaling messages further comprises: transforming the decoded third checksum value by a transformation constant; re-computing the vehicle-side secret key based on a vehicle-side public key; re-encoding the one or more vehicle marshaling messages; and re-transforming the transformed third checksum value by the transformation constant; wherein the calculation of the fourth checksum further comprises: appending the re-computed vehicle-side secret key to the re-encoded one or more vehicle marshaling messages; and transforming the re-transformed third checksum value by the transformation constant; wherein the verification of the one or more vehicle marshaling messages further comprises: determining whether a data length associated with the re-encoded one or more vehicle marshaling messages corresponds to the data length associated with the decoded data length; and further comprising: establishing a communication link between the automated vehicle and the infrastructure system based on successfully determining that the fourth checksum value corresponds to the third checksum value.

The present disclosure provides another method for initiating autonomous control of an automated vehicle, the method comprising: receiving, at a vehicle processing system of the automated vehicle, one or more infrastructure marshaling messages that includes a first checksum value in response to the automated vehicle being located within a distance-related threshold from an infrastructure system; verifying the one or more infrastructure marshaling messages; calculating, by one or more processors of the vehicle processing system, a second checksum value based on a vehicle-side secret key and encoded data associated with the infrastructure system in response to the verification of the one or more infrastructure marshaling messages; transmitting, to the infrastructure system, one or more vehicle marshaling messages that includes a third checksum value based on the second checksum value; and wherein the verification of the one or more infrastructure marshaling messages includes: decoding the one or more infrastructure marshaling messages, calculating a fourth checksum value based on the infrastructure-side secret key in response to decoding the one or more infrastructure marshaling messages, and determining whether the fourth checksum value corresponds to the first checksum value; wherein the calculation of the second checksum value further comprises: transforming the vehicle-side secret key by a transformation constant; and appending the transformed vehicle-side secret key to the encoded data associated with the infrastructure system; further comprising: calculating the third checksum value based on a transformation constant; wherein the one or more vehicle marshaling messages further includes the encoded data associated with the automated vehicle, a data length associated with the one or more vehicle marshaling messages, or a combination thereof; wherein the one or more infrastructure marshaling messages further includes the encoded data associated with the automated vehicle, a data length associated with the one or more infrastructure marshaling messages, or a combination thereof; wherein decoding the one or more infrastructure marshaling messages further comprises: decoding the first checksum value; decoding a data length associated with the one or more infrastructure marshaling messages; and decoding the encoded data associated with the infrastructure system; wherein the verification of the one or more infrastructure marshaling messages further comprises: transforming the decoded first checksum value by a transformation constant; re-computing the infrastructure-side secret key based on an infrastructure-side public key; re-encoding the one or more infrastructure marshaling messages; and re-transforming the transformed first checksum value by the transformation constant; wherein the calculation of the fourth checksum further comprises: appending the re-computed infrastructure-side secret key to the re-encoded one or more infrastructure marshaling messages; and transforming the re-transformed first checksum value by the transformation constant; and wherein the verification of the one or more infrastructure marshaling messages further comprises: determining whether a data length associated with the re-encoded one or more infrastructure marshaling messages corresponds to a data length associated with the decoded data length.

The present disclosure provides a system for initiating autonomous control of an automated vehicle, the system comprising: one or more processors of an infrastructure system configured to: calculate a first checksum value based on an infrastructure-side secret key and encoded data associated with the automated vehicle located within a distance-related threshold from the infrastructure system, transmit one or more infrastructure marshaling messages that includes a second checksum value based on the first checksum value, receive one or more vehicle marshaling messages that includes a third checksum value based on a vehicle-side secret key in response to the vehicle verifying the second checksum value, verifying the one or more vehicle marshaling messages; and a vehicle processing system of the automated vehicle configured to: receive the one or more infrastructure marshaling messages, verify the one or more infrastructure marshaling messages, calculate the third checksum value based on a vehicle-side secret key and encoded data associated with the infrastructure system in response to the verification of the one or more infrastructure marshaling messages, and transmit the one or more vehicle marshaling messages.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example system for automated vehicle marshaling in accordance with one or more embodiments of the present disclosure;

FIG. 2 is a flowchart illustrating an example method for computing and/or verifying data integrity associated with an exchange of one or more messages;

FIG. 3 is a flowchart illustrating another example method for computing and/or verifying data integrity associated with the exchange of one or more messages;

FIGS. 4A and 4C illustrate a computation of data integrity associated with an exchange of one or more messages;

FIGS. 4B and 4D illustrate a verification of data integrity associated with an exchange of one or more messages;

FIG. 5 is a flowchart illustrating yet another example method for computing and/or verifying data integrity associated with the exchange of one or more messages;

FIG. 6 is a flowchart illustrating an additional example method for computing and/or verifying data integrity associated with the exchange of one or more messages; and

FIG. 7 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provides a means for computing and/or verifying data integrity associated with one or more messages exchanged between an automated vehicle and a central server. In one or more examples, the computation and verification of the message(s) protects the data integrity of the message(s) during transmission of the message(s) between the automated vehicle and the central server. In one or more examples, the computation and verification of the data integrity associated with message(s) provides a synchronized process to check whether all data bits associated with each of the message(s) is received at an intended recipient and/or whether any data bits are lost, flipped, or are associated with any errors during transmission of the message(s) between the automated vehicle and the central server. In one or more examples, the computation and verification of the data integrity associated with the message(s) assists in defining a functional protective approach for computing and/or verifying a payload associated with the message(s).

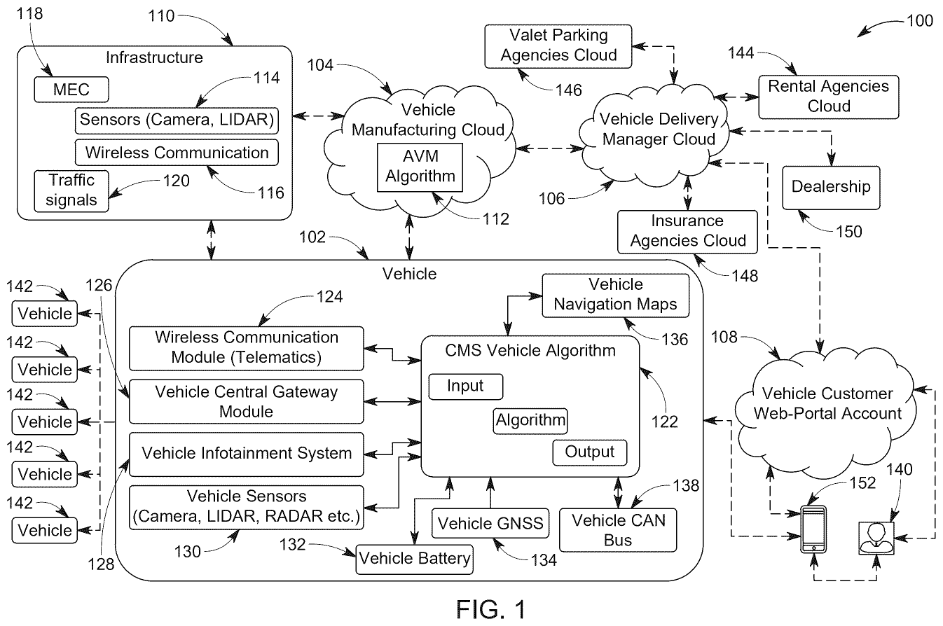

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

The vehicle manufacturing cloud system 104 can include an infrastructure-side AVM algorithm 112. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment. For example, the marshaling environment can represent a plant marshaling setting, an automated charging setting, a depot marshaling setting, an underground parking setting, among others. As an example, the plant marshaling setting can include an instance wherein just-built vehicles are moved through end-of-line testing at a vehicle assembly plant via overhead vision sensing. As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the underground parking setting can include an instance wherein vehicles are moved through underground or covered parking environments with a potentially inconsistent communication network such as a global navigation satellite system.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is further configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes a sensor component 114, a wireless communication component 116, a multi-access edge computing (MEC) system 118, and one or more traffic signals 120. In general, and as is described herein, the infrastructure system 110 is configured to compute and/or verify one or more messages exchanged between the infrastructure system 110 and the one or more vehicles. For example, the infrastructure system 110 is configured to compute and/or verify one or more messages exchanged between the infrastructure system 110 and the one or more vehicles before marshaling of the one or more vehicles can commence. However, it is understood that the infrastructure system 110 is configured to compute and/or verify one or more messages exchanged between the infrastructure system 110 and the one or more vehicles at any time associated with a marshaling process. In one or more examples, the infrastructure-side AVM algorithm 112 is configured to perform the computation and/or verification of the one or more messages exchanged between the infrastructure system 110 and the one or more vehicles.

It is understood that the MEC system 118 is configured to support communication between the wireless communication component 116 and the vehicle 102. It is further understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth® to communicate with the one or more vehicles.

The wireless communication component 116 also communicates with the sensor component 114 that is configured to communicate with and/or manage a set of infrastructure sensors that can include one or more cameras, lidar, radar, and/or ultrasonic devices configured to monitor the movement of the one or more vehicles through the marshaling environment. In one or more examples, the sensor component 114 is also configured to perform one or more localization functions associated with marshaling the one or more vehicles such as, but not limited to, perception, path-planning, detection, controls, and/or receiving and analyzing response(s) from each vehicle of the one or more vehicles.

The wireless communication component 116 is also in communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits a wall or another vehicle and is then reflected back to the vehicle 102. Based on the amount of time it takes for the sound wave to return to the vehicle 102, the vehicle 102 can determine the distance between the one or more vehicle sensors 130 and the wall or the other vehicle. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the wall or the other vehicle and is then reflected back to the vehicle 102. Based on the amount of time it takes for the electromagnetic waves to return to the vehicle 102, the vehicle 102 can determine a range, velocity, and angle of the vehicle 102 relative to the wall or the other vehicle.

The one or more vehicle sensors 130 communicate information associated with the position and/or distance at which the vehicle 102 is relative to the wall or the other vehicle to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period of at least one day that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agencies cloud system 144, a valet parking agencies cloud system 146, an insurance agencies cloud system 148, and/or a dealership system 150. The vehicle delivery manager cloud system 106 is configured to facilitate the delivery of the one or more vehicles to any of a rental agency (not shown) associated with the rental agencies cloud system 144, a valet parking agency (not shown) associated with the valet parking agencies cloud system 146, an insurance agency (not shown) associated with the insurance agencies cloud system 148, and/or the dealership system 150. The vehicle delivery manager cloud system 106 also wirelessly communicates with the vehicle customer web-portal account cloud system 108. It should be understood that other cloud systems can be included, in one or more examples.

The vehicle delivery manager cloud system 106 wirelessly communicates with a user device 152 such as a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agencies cloud system 144, the valet parking agency associated with the valet parking agencies cloud system 146, the insurance agency associated with the insurance agencies cloud system 148, and/or the dealership system 150.

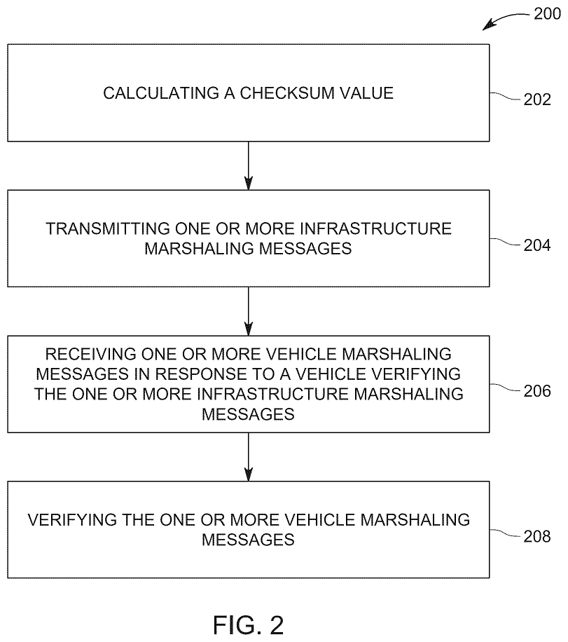

FIG. 2 is a flowchart illustrating an example method 200 for computing and/or verifying data integrity associated with one or more infrastructure marshaling messages (IMMs) and one or more vehicle marshaling messages (VMMs) exchanged between an automated vehicle (e.g., the vehicle 102) and an infrastructure system (e.g., the infrastructure system 110).

At operation 202, one or more processors of the infrastructure system is configured to calculate a first checksum value. In one or more examples, the first checksum value is calculated based on an infrastructure-side secret key and/or encoded data associated with the automated vehicle located within a distance-related threshold from the infrastructure system. As another example, the distance-related threshold can be any distance-related range from the infrastructure system at which the automated vehicle may maintain a communication link with the infrastructure system. In one or more embodiments, the calculation of the first checksum value includes transforming the infrastructure-side secret key by a transformation constant and/or appending the transformed infrastructure-side secret key to the encoded data associated with the automated vehicle.

At operation 204, the infrastructure system is configured to transmit one or more IMMs to the automated vehicle. In one or more examples, the one or more IMMs includes a second checksum value. As another example, and in one or more embodiments, the second checksum value is calculated based on the first checksum value and/or the transformation constant. As yet another example, the one or more IMMs further includes the encoded data associated with the automated vehicle, a data length associated with the one or more IMMs, or a combination thereof.

At operation 206, the infrastructure system is configured to receive one or more VMMs from the automated vehicle. In one or more examples the one or more VMMs includes a third checksum value. As another example, the third checksum value is calculated based a vehicle-side secret key. As a further example, the third checksum value is calculated in response to the automated vehicle verifying the one or more IMMs. As yet another example, the one or more VMMs further includes the encoded data associated with the automated vehicle, a data length associated with the one or more VMMs, or a combination thereof.

At operation 208, the infrastructure system is configured to verify the one or more VMMs. In one or more examples, the verification of the one or more VMMs includes decoding the one or more VMMs. As another example, and in one or more embodiments, the decoding of the one or more VMMs includes decoding the third checksum value, decoding a data length associated with the one or more VMMs, and/or decoding the encoded data associated with the automated vehicle. As a further example, and in one or more embodiments, the verification of the one or more VMMs includes transforming the decoded third checksum value by the transformation constant, re-computing the vehicle-side secret key based on a vehicle-side public key, re-encoding the one or more VMMs, and/or re-transforming the transformed third checksum value by the transformation constant.

The verification of the one or more VMMs also includes calculating a fourth checksum value. For example, the calculation of the fourth checksum value is based on the vehicle-side secret key. As another example, the fourth checksum value is calculated in response to decoding the one or more VMMs. As yet another example, and in one or more embodiments, the calculation of the fourth checksum includes appending the re-computed vehicle-side secret key to the re-encoded one or more VMMs and/or transforming the re-transformed third checksum value by the transformation constant.

The verification of the one or more VMMs further includes determining whether the fourth checksum value corresponds to the third checksum value. It is understood that the fourth checksum value can correspond to the third checksum value in a case wherein the fourth checksum value matches (e.g., is the same as) the third checksum value and/or the fourth checksum value is within an acceptable range or variance of the third checksum value. It is understood that the fourth checksum value can correspond to the third checksum value based on any relationship function and can be determined by one or more algorithmic functions associated with the one or more processors of the infrastructure system. It is also understood that the acceptable range can be predefined or determined in real-time by the one or more algorithmic functions.

In one or more embodiments, the verification of the one or more VMMs can also include determining whether a data length associated with the re-encoded one or more VMMs corresponds to the data length associated with the decoded data length. It is understood that the data length associated with the re-encoded one or more VMMs can correspond to the data length associated with the decoded data length in a case wherein the data length associated with the re-encoded one or more VMMs matches (e.g., is the same length as) the data length associated with the decoded data length and/or the data length associated with the re-encoded one or more VMMs is within an acceptable range or variance of the data length associated with the decoded data length. It is understood that the data length associated with the re-encoded one or more VMMs can correspond to the data length associated with the decoded data length based on any relationship function and can be determined by one or more algorithmic functions associated with the one or more processors of the infrastructure system. It is also understood that the acceptable range can be predefined or determined in real-time by the one or more algorithmic functions.

In one or more embodiments, a communication link between the automated vehicle and the infrastructure system is thereby established. In one or more examples, the communication link is established based on successfully determining that the fourth checksum value corresponds to the third checksum value.

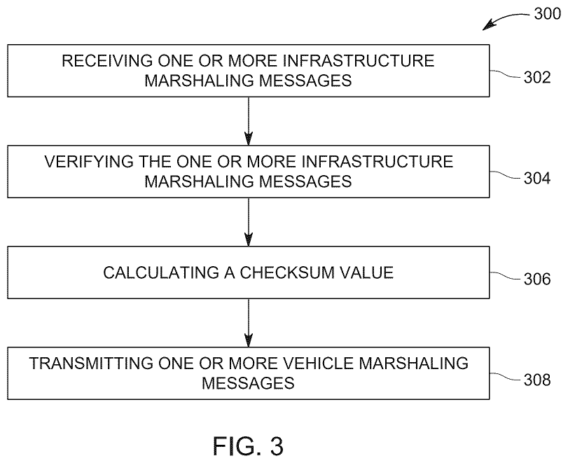

FIG. 3 is another flowchart illustrating an example method 300 for computing and/or verifying data integrity associated with one or more infrastructure marshaling messages (IMMs) and one or more vehicle marshaling messages (VMMs) exchanged between an automated vehicle (e.g., the vehicle 102) and an infrastructure system (e.g., the infrastructure system 110).

At operation 302, a vehicle processing system of the automated vehicle is configured to receive one or more IMMs. In one or more examples, the one or more IMMs includes a first checksum value. As another example, the one or more IMMs are received in response to the automated vehicle being located within a distance-related threshold from an infrastructure system. As another example, the distance-related threshold can be any distance-related range from the infrastructure system at which the automated vehicle may maintain a communication link with the infrastructure system. As yet another example, the one or more IMMs further includes the encoded data associated with the automated vehicle, a data length associated with the one or more IMMs, or a combination thereof.

At operation 304, one or more processors of the vehicle processing system is configured to verify the one or more IMMs. In one or more examples, the verification of the one or more IMMs includes decoding the one or more IMMs. As another example, and in one or more embodiments, the decoding of the one or more IMMs includes decoding the first checksum value, decoding a data length associated with the one or more IMMs and/or decoding the encoded data associated with the infrastructure system. As a further example, and in one or more embodiments, the verification of the one or more IMMs includes transforming the decoded first checksum value by a transformation constant, re-computing the infrastructure-side secret key based on an infrastructure-side public key, re-encoding the one or more IMMs, and/or re-transforming the transformed first checksum value by the transformation constant.

The verification of the one or more IMMs also includes calculating a fourth checksum. For example, the calculation of the fourth checksum value is based on the infrastructure-side secret key. As another example, the fourth checksum value is calculated in response to decoding the one or more IMMs. As yet another example, and in one or more embodiments, the calculation of the fourth checksum includes appending the re-computed infrastructure-side secret key to the re-encoded one or more infrastructure marshaling messages and/or transforming the re-transformed first checksum value by the transformation constant.

The verification of the one or more IMMs further includes determining whether the fourth checksum value corresponds to the first checksum value. It is understood that the fourth checksum value can correspond to the first checksum value in a case wherein the fourth checksum value matches (e.g., is the same as) the first checksum value and/or the fourth checksum value is within an acceptable range or variance of the first checksum value. It is understood that the fourth checksum value can correspond to the first checksum value based on any relationship function and can be determined by one or more algorithmic functions associated with the one or more processors of the infrastructure system. It is also understood that the acceptable range can be predefined or determined in real-time by the one or more algorithmic functions.

In one or more embodiments, the verification of the one or more IMMs can also include determining whether a data length associated with the re-encoded one or more infrastructure marshaling messages corresponds to a data length associated with the decoded data length. It is understood that the data length associated with the re-encoded one or more IMMs can correspond to the data length associated with the decoded data length in a case wherein the data length associated with the re-encoded one or more IMMs matches (e.g., is the same length as) the data length associated with the decoded data length and/or the data length associated with the re-encoded one or more IMMs is within an acceptable range or variance of the data length associated with the decoded data length. It is understood that the data length associated with the re-encoded one or more IMMs can correspond to the data length associated with the decoded data length based on any relationship function and can be determined by one or more algorithmic functions associated with the one or more processors of the infrastructure system. It is also understood that the acceptable range can be predefined or determined in real-time by the one or more algorithmic functions.

At operation 306, the one or more processors of the vehicle processing system is configured to calculate a second checksum value. In one or more examples, the second checksum value is calculated based on a vehicle-side secret key and/or encoded data associated with the infrastructure system. As another example, the second checksum value is calculated in response to the verification of the one or more IMMs. As a further example, and in one or more embodiments, the calculation of the second checksum value includes transforming the vehicle-side secret key by the transformation constant and/or appending the transformed vehicle-side secret key to the encoded data associated with the infrastructure system.

At operation 308, the vehicle system is configured to transmit one or more VMMs to the infrastructure system. In one or more examples, the one or more VMMs includes a third checksum value. As another example, and in one or more embodiments, the third checksum value is calculated based on the second checksum value and/or or the transformation constant. As yet another example, the one or more VMMs further includes the encoded data associated with the automated vehicle, a data length associated with the one or more vehicle marshaling messages, or a combination thereof.

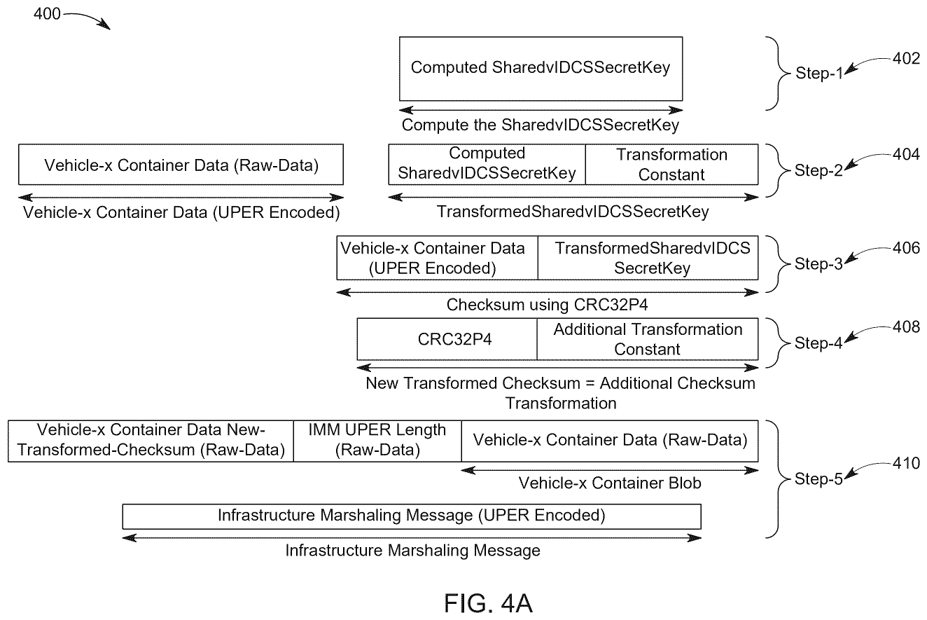

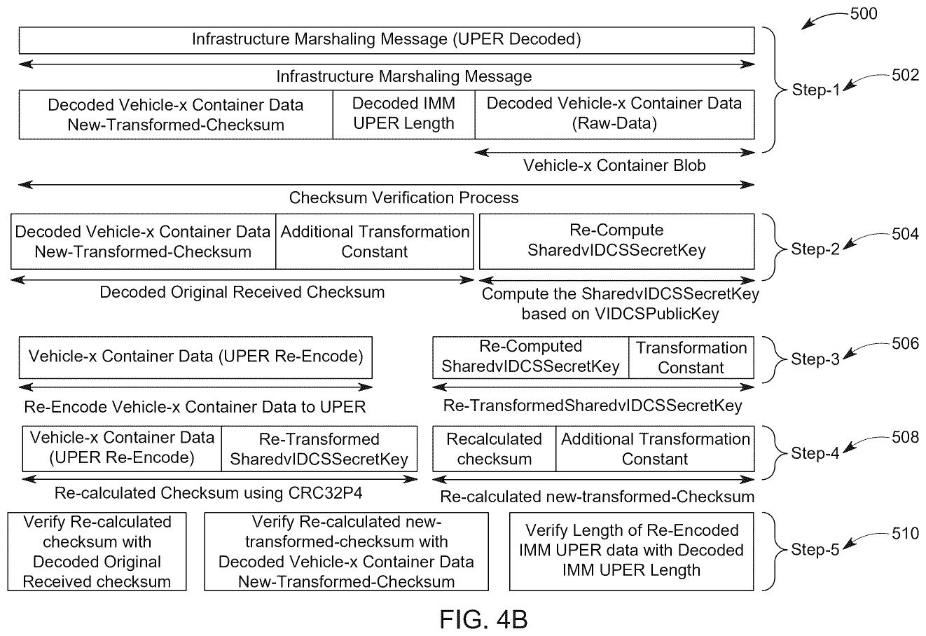

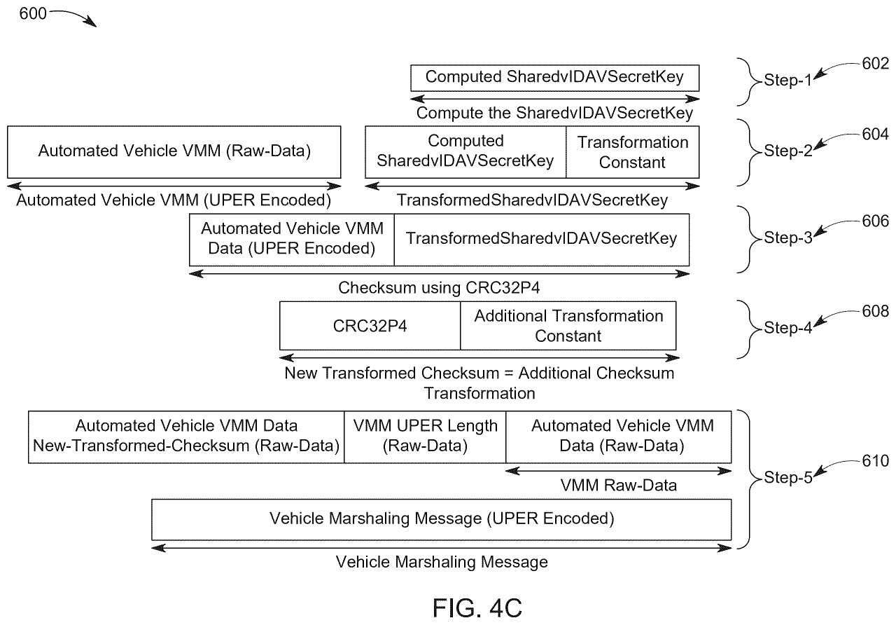

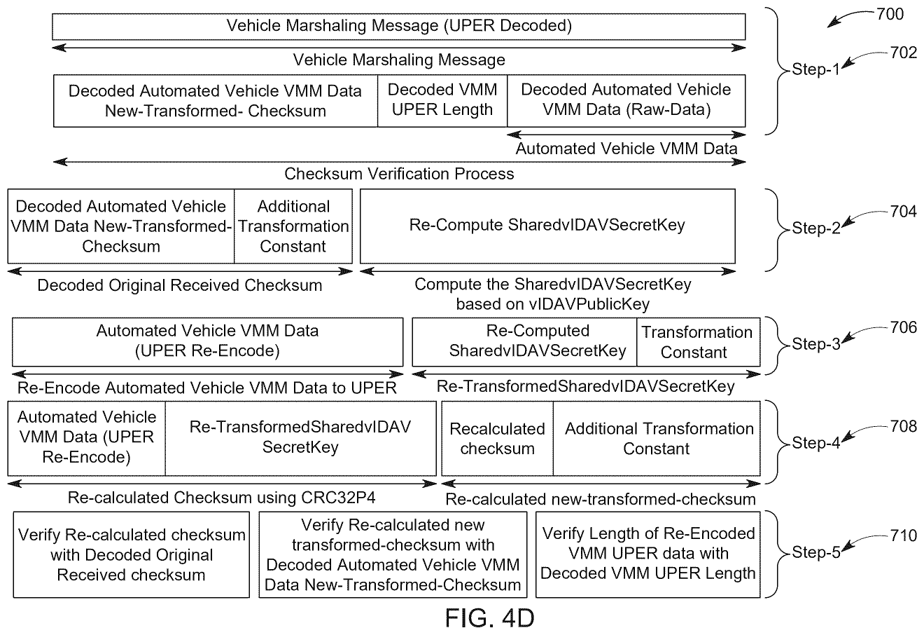

It is understood that, in one or more embodiments, the methods described herein and that are related to the operations discussed in FIGS. 2 and 3, respectively, are embodied in the example processes described in FIGS. 4A-4D. Specifically, FIG. 4A illustrates an example process 400 for computation of an IMM-related checksum performed by the infrastructure-side AVM algorithm 112 of the infrastructure system 110. In one or more examples, the infrastructure-side AVM algorithm 112 is configured to compute a SharedvIDCSSecretKey at step 402.

The infrastructure-side AVM algorithm 112 is also configured to compute unaligned packed encoding rules (UPER) and encode vehicle-x container data (e.g., the encoded data associated with the automated vehicle) as well as calculate a TransformedSharedvIDCSSecretKey (e.g., the infrastructure-side secret key) at step 404. In one or more examples, the TransformedSharedvIDCSSecretKey is calculated based on appending a transformation constant to the computed SharedvIDCSSecretKey. As another example, the vehicle-x container data can be filled with raw-data or any type of data format. It is understood that the transformation constant can be a standard constant applicable to any process for computation of an IMM-related checksum. However, it is also understood that the transformation constant can be a unique constant respective to different vehicles associated with a computation of an IMM-related checksum.

The infrastructure-side AVM algorithm 112 is further configured to calculate a checksum at step 406. In one or more examples, the checksum calculated at step 406 is representative of the first checksum value described in relation to FIG. 2. In one or more examples, the checksum is calculated based on appending the UPER encoded container data to the TransformedSharedvIDCSSecretKey. It is understood that while the checksum is calculated in a 32-bit format as illustrated in FIG. 4A, any format may be utilized in the calculation of the checksum.

The infrastructure-side AVM algorithm 112 is additionally configured to calculate a New-Transformed-Checksum at step 408. In one or more examples, the New-Transformed-Checksum calculated at step 408 is representative of the second checksum value described in relation to FIG. 2 and the first checksum value described in relation to FIG. 3. In one or more examples, the New-Transformed-Checksum is calculated based on appending the checksum calculated at step 406 to an additional transformation constant. It is understood that the additional transformation constant can be the same as the transformation constant appended to the SharedvIDCSSecretKey at step 404. However, it is also understood that the additional transformation constant can be different than the transformation constant appended to the SharedvIDCSSecretKey at step 404.

Moreover, the infrastructure-side AVM algorithm 112 is configured to generate (e.g., create) a vehicle-x container Binary Large Object (blob) at step 410. In one or more examples, the vehicle-x container blob includes a vehicle-x container data New-Transformed-Checksum, an IMM UPER length, and vehicle-x container data. It is understood that each of the vehicle-x container data New-Transformed-Checksum, the IMM UPER length, and the vehicle-x container data can correspond to raw-data associated with the vehicle-x container data discussed in relation to step 404. However, it is understood that each of the vehicle-x container data New-Transformed-Checksum, the IMM UPER length, and the vehicle-x container data can also correspond to any type of data format. An IMM payload is also generated at step 410. In one or more examples, the IMM payload corresponds to an UPER encoded representation of each of the vehicle-x container data New-Transformed-Checksum, the IMM UPER length, and the vehicle-x container data. In one or more examples, the infrastructure system 110 is also configured to transmit the IMM payload to the vehicle 102.

FIG. 4B illustrates an example process 500 for verification of the IMM-related checksum performed by the vehicle-side AVM algorithm 122 of the vehicle 102. In one or more examples, the process 500 is initiated when the vehicle-side AVM algorithm 122 determines that an identityManagement associated with the received IMM payload matches the vehicle 102 that is in receipt of the IMM payload. In one or more examples, the process 500 is also initiated when the vehicle-side AVM algorithm 122 determines that the IMM payload received at the vehicle 102 is fresh (e.g., newly generated and/or received at the vehicle 102). It is understood that the process 500 can be initiated based on the vehicle-side AVM algorithm 122 determining that the identityManagement associated with the received IMM payload matches the vehicle 102 and/or that the IMM payload received at the vehicle 102 is fresh.

In one or more examples, the vehicle-side AVM algorithm 122 is configured to UPER decode the IMM payload received at the vehicle 102 at step 502. Specifically, in UPER decoding the IMM payload, and also at step 502, the vehicle-side AVM algorithm 122 also UPER decodes each of the vehicle-x container data New-Transformed-Checksum, the IMM UPER length, and the vehicle-x container data (e.g., the vehicle-x container blob). In one or more examples, the vehicle 102 is configured to store the decoded vehicle-x container blob in a database (not shown) associated with the vehicle 102. It is understood that the database can be externally and/or internally disposed in relation to the vehicle 102.

The vehicle-side AVM algorithm 122 is also configured to calculate a decoded original received checksum at step 504. In one or more examples, the decoded original received checksum is calculated based on appending an additional transformation constant to the decoded vehicle-x container data New-Transformed-Checksum. It is understood that the additional transformation constant can be the same as the transformation constant appended to the SharedvIDCSSecretKey at step 404. However, it is also understood that the additional transformation constant can be different than the transformation constant appended to the SharedvIDCSSecretKey at step 404. The vehicle-side AVM algorithm 122 is further configured to re-compute the SharedvIDCSSecretKey at step 504. In one or more examples, the SharedvIDCSSecretKey is re-computed based on a VIDCSPublicKey (e.g., the infrastructure-side public key) associated with the infrastructure system 110.

The vehicle-side AVM algorithm 122 is further configured to UPER re-encode the vehicle-x container data as well as calculate a Re-TransformedSharedvIDCSSecretKey at step 506. In one or more examples, the Re-TransformedSharedvIDCSSecretKey is calculated by appending the re-computed SharedvIDCSSecretKey to the transformation constant. It is understood that the transformation constant can be the same as the transformation constant appended to the SharedvIDCSSecretKey at step 404. However, it is also understood that the transformation constant can be different than the transformation constant appended to the SharedvIDCSSecretKey at step 404.

The vehicle-side AVM algorithm 122 is additionally configured to re-calculate the checksum (e.g., the checksum described in relation to step 406) at step 508. In one or more examples, the checksum is re-calculated by appending the re-encoded vehicle-x container data to the Re-TransformedSharedvIDCSSecretKey. The vehicle-side AVM algorithm 122 is also configured to re-calculate the New-Transformed-Checksum (e.g., the New-Transformed-Checksum described in relation to step 408) at step 508. In one or more examples, the New-Transformed-Checksum recalculated at step 508 is representative of the fourth checksum value described in relation to FIG. 3. In one or more examples, the New-Transformed-Checksum is re-calculated by appending the re-calculated checksum to the additional transformation constant. It is understood that the additional transformation constant can be the same as the transformation constant appended to the SharedvIDCSSecretKey at step 404. However, it is also understood that the additional transformation constant can be different than the transformation constant appended to the SharedvIDCSSecretKey at step 404.

The vehicle-side AVM algorithm 122 is further configured to determine (e.g., verify) whether the re-calculated checksum matches (e.g., is the same as) the decoded original received checksum at step 510. The vehicle-side AVM algorithm 122 is also configured to determine (e.g., verify) whether the re-calculated New-Transformed-Checksum matches (e.g., is the same as) the decoded vehicle-x container data New-Transformed-Checksum at step 510. The vehicle-side AVM algorithm 122 is additionally configured to determine (e.g., verify) whether a length of the re-encoded IMM UPER data matches (e.g., is the same length as) the length of the decoded IMM UPER data at step 510.

FIG. 4C illustrates an example process 600 for computation of a VMM-related checksum performed by the vehicle-side AVM algorithm 122 of the vehicle 102. In one or more examples, the vehicle-side AVM algorithm 122 is configured to compute a SharedvIDAVSecretKey at step 602.

The vehicle-side AVM algorithm 122 is also configured to UPER encode data of the VMM(s) associated with the vehicle 102 as well as calculate a TransformedSharedvIDAVSecretKey (e.g., the vehicle-side secret key) at step 604. In one or more examples, the TransformedSharedvIDAVSecretKey is calculated based on appending a transformation constant to the computed SharedvIDAVSecretKey. As another example, the UPER encoded data of the VMM(s) can be provided in a form of raw-data or any type of data format. It is understood that the transformation constant can be the same as the transformation constant appended to the SharedvIDCSSecretKey at step 404. However, it is also understood that the transformation constant can be different than the transformation constant appended to the SharedvIDCSSecretKey at step 404.

The vehicle-side AVM algorithm 122 is further configured to calculate a checksum at step 606. In one or more examples, the checksum calculated at step 606 is representative of the second checksum value described in relation to FIG. 3. In one or more examples, the checksum is calculated based on appending the UPER encoded data of the VMM(s) to the TransformedSharedvIDAVSecretKey. It is understood that while the checksum is calculated in a 32-bit format as illustrated in FIG. 4C, any format may be utilized in the calculation of the checksum.

The vehicle-side AVM algorithm 122 is additionally configured to calculate a New-Transformed-Checksum at step 608. In one or more examples, the checksum calculated at step 608 is representative of the third checksum value described in relation to both FIGS. 2 and 3. In one or more examples, the New-Transformed-Checksum is calculated based on appending the checksum calculated at step 606 to an additional transformation constant. It is understood that the additional transformation constant can be the same as the transformation constant appended to the SharedvIDCSSecretKey at step 404. However, it is also understood that the additional transformation constant can be different than the transformation constant appended to the SharedvIDCSSecretKey at step 404.

Moreover, the vehicle-side AVM algorithm 122 is configured to generate (e.g., create) raw data associated with the VMM(s) at step 610. In one or more examples, the raw data associated with the VMM(s) includes the data associated with the VMM(s) in relation to the New-Transformed-Checksum, a VMM UPER length, and the data associated with the VMM(s) in relation to VMM data. It is understood that each of the data associated with the VMM(s) in relation to the New-Transformed-Checksum, the VMM UPER length, and the data associated with the VMM(s) in relation to VMM data can correspond to raw-data associated with the data of the VMM(s) in relation to step 604. However, it is understood that each of the data associated with the VMM(s) in relation to the New-Transformed-Checksum, the VMM UPER length, and the data associated with the VMM(s) in relation to VMM data can also correspond to any type of data format. A VMM payload is also generated at step 610. In one or more examples, the VMM payload corresponds to an UPER encoded representation of each of the data associated with the VMM(s) in relation to the New-Transformed-Checksum, the VMM UPER length, and the data associated with the VMM(s) in relation to VMM data. In one or more examples, the vehicle 102 is also configured to transmit the VMM payload to the infrastructure system 110.

FIG. 4D illustrates an example process 700 for verification of the VMM-related checksum performed by the infrastructure-side AVM algorithm 112 of the infrastructure system 110. In one or more examples, the process 700 is initiated when the infrastructure-side AVM algorithm 112 determines that an identityManagement associated with the received VMM payload matches a rollingCounterOfIMMReceived relative to the transmitted VMM payload.

In one or more examples, the infrastructure-side AVM algorithm 112 is configured to UPER decode the VMM payload received at the infrastructure system 110 at step 702. Specifically, in UPER decoding the VMM payload, and also at step 702, the infrastructure-side AVM algorithm 112 also UPER decodes each of the VMM(s) in relation to the New-Transformed-Checksum, the VMM UPER length, and the data associated with the VMM(s) in relation to VMM data (e.g., automated vehicle VMM data). In one or more examples, the infrastructure system 110 is configured to store the decoded automated vehicle VMM data in a database (not shown) associated with the infrastructure system 110. It is understood that the database can be externally and/or internally disposed in relation to the infrastructure system 110.

The infrastructure-side AVM algorithm 112 is also configured to calculate a decoded original received checksum at step 704. In one or more examples, the decoded original received checksum is calculated based on appending an additional transformation constant to the decoded VMM(s) in relation to the New-Transformed-Checksum. It is understood that the additional transformation constant can be the same as the transformation constant appended to the SharedvIDCSSecretKey at step 404. However, it is also understood that the additional transformation constant can be different than the transformation constant appended to the SharedvIDCSSecretKey at step 404. The infrastructure-side AVM algorithm 112 is further configured to re-compute the SharedvIDAVSecretKey at step 704. In one or more examples, the SharedvIDAVSecretKey is re-computed based on a VIDAVPublicKey (e.g., the vehicle-side public key) associated with the vehicle 102.

The infrastructure-side AVM algorithm 112 is further configured to UPER re-encode the data associated with the VMM(s) in relation to VMM data as well as calculate a Re-TransformedSharedvIDAVSecretKey at step 706. In one or more examples, the Re-TransformedSharedvIDAVSecretKey is calculated by appending the re-computed SharedvIDAVSecretKey to the transformation constant. It is understood that the transformation constant can be the same as the transformation constant appended to the SharedvIDCSSecretKey at step 404. However, it is also understood that the transformation constant can be different than the transformation constant appended to the SharedvIDCSSecretKey at step 404.

The infrastructure-side AVM algorithm 112 is additionally configured to re-calculate the checksum (e.g., the checksum described in relation to step 606) at step 708. In one or more examples, the checksum is re-calculated by appending the re-encoded data associated with the VMM(s) in relation to VMM data to the Re-TransformedSharedvIDAVSecretKey. The infrastructure-side AVM algorithm 112 is also configured to re-calculate the New-Transformed-Checksum (e.g., the New-Transformed-Checksum described in relation to step 608) at step 708. In one or more examples, the New-Transformed-Checksum re-calculated at step 708 is representative of the fourth checksum value described in relation to FIG. 2. In one or more examples, the New-Transformed-Checksum is re-calculated by appending the re-calculated checksum to the additional transformation constant. It is understood that the additional transformation constant can be the same as the transformation constant appended to the SharedvIDCSSecretKey at step 404. However, it is also understood that the additional transformation constant can be different than the transformation constant appended to the SharedvIDCSSecretKey at step 404.

The infrastructure-side AVM algorithm 112 is further configured to determine (e.g., verify) whether the re-calculated checksum matches (e.g., is the same as) the decoded original received checksum at step 710. The infrastructure-side AVM algorithm 112 is also configured to determine (e.g., verify) whether the re-calculated New-Transformed-Checksum matches (e.g., is the same as) the decoded VMM(s) in relation to the New-Transformed-Checksum at step 710. The infrastructure-side AVM algorithm 112 is additionally configured to determine (e.g., verify) whether a length of the re-encoded VMM UPER data matches (e.g., is the same length as) the length of the decoded VMM UPER data at step 710.

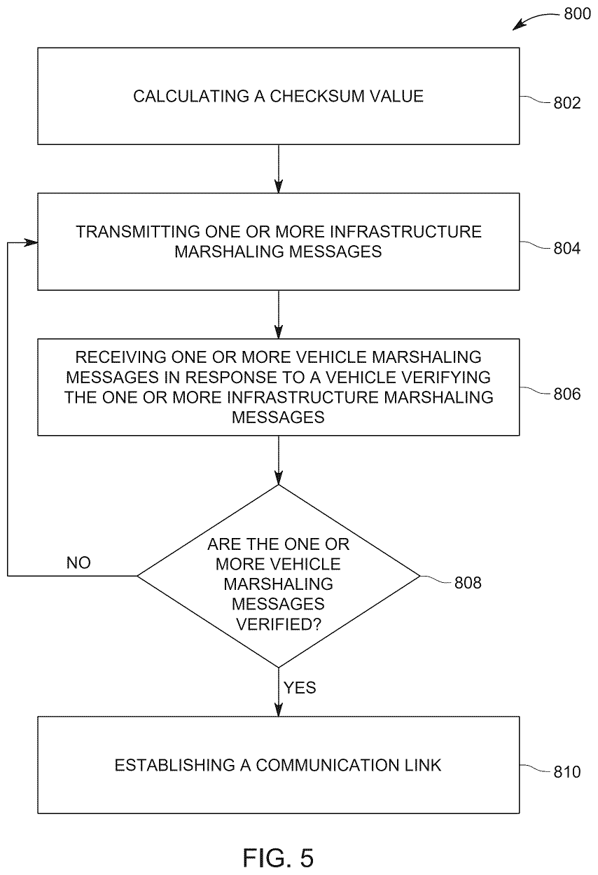

FIG. 5 is a flowchart illustrating an additional example method 800 for computing and/or verifying data integrity associated with one or more infrastructure marshaling messages (IMMs) and one or more vehicle marshaling messages (VMMs) exchanged between an automated vehicle (e.g., the vehicle 102) and an infrastructure system (e.g., the infrastructure system 110).

At operation 802, one or more processors of the infrastructure system is configured to calculate a first checksum value. In one or more examples, the first checksum value is calculated based on an infrastructure-side secret key and/or encoded data associated with the automated vehicle located within a distance-related threshold from the infrastructure system. As another example, the distance-related threshold can be any distance-related range from the infrastructure system at which the automated vehicle may maintain a communication link with the infrastructure system.

At operation 804, the infrastructure system is configured to transmit one or more IMMs to the automated vehicle. In one or more examples, the one or more IMMs includes a second checksum value. As another example, and in one or more embodiments, the second checksum value is calculated based on the first checksum value and/or the transformation constant.

At operation 806, the infrastructure system is configured to receive one or more VMMs from the automated vehicle. In one or more examples the one or more VMMs includes a third checksum value. As another example, the third checksum value is calculated based a vehicle-side secret key. As a further example, the third checksum value is calculated in response to the automated vehicle verifying the one or more IMMs.

At operation 808, the infrastructure system is further configured to make a determination regarding whether the one or more VMMs are verified. In one or more examples, the verification of the one or more VMMs includes at least decoding the one or more VMMs. The verification of the one or more VMMs also includes at least calculating a fourth checksum value. The verification of the one or more VMMs further includes at least determining whether the fourth checksum value corresponds to the third checksum value.

In one or more examples, and in an instance wherein a determination is made that the one or more VMMs are not verified, the transmission of the one or more IMMs (e.g., at operation 804) is repeated. It is understood that because the operation 804 is repeated, the original transmission of the one or more VMMs is not utilized by the infrastructure system and a report can be generated that can include any data-related information associated with one or more explanations as to why the one or more VMMs are not verified. However, in other examples, and in an instance wherein a determination is made at operation 808 that the one or more VMMs are verified, a communication link is established between the automated vehicle and the infrastructure system at operation 810.

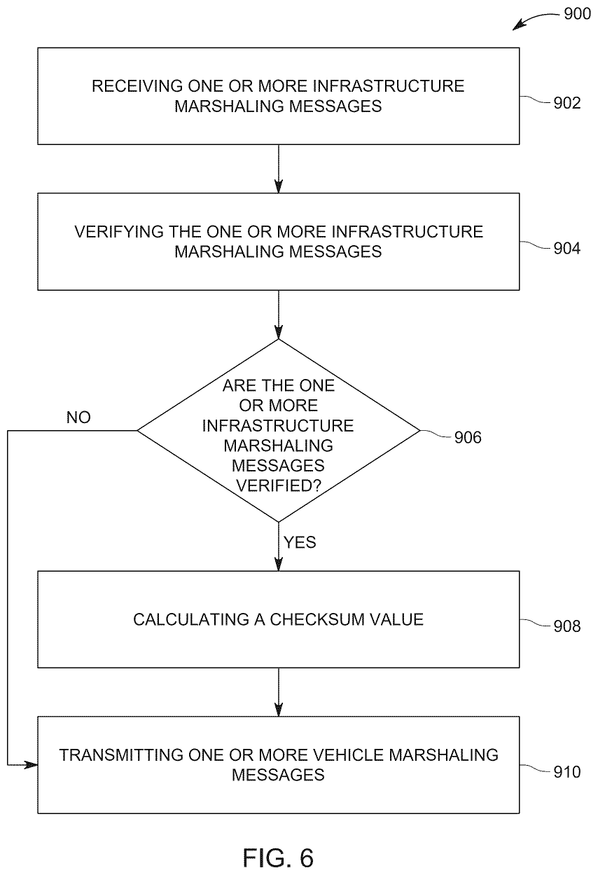

FIG. 6 is another flowchart illustrating yet another example method 900 for computing and/or verifying data integrity associated with one or more infrastructure marshaling messages (IMMs) and one or more vehicle marshaling messages (VMMs) exchanged between an automated vehicle (e.g., the vehicle 102) and an infrastructure system (e.g., the infrastructure system 110).

At operation 902, a vehicle processing system of the automated vehicle is configured to receive one or more IMMs. In one or more examples, the one or more IMMs includes a first checksum value based on an infrastructure-side secret key and/or encoded data associated with the automated vehicle in response to the automated vehicle being located within a distance-related threshold from an infrastructure system. As another example, the distance-related threshold can be any distance-related range from the infrastructure system at which the automated vehicle may maintain a communication link with the infrastructure system.

At operation 904, one or more processors of the vehicle processing system is configured to verify the one or more IMMs. At operation 906, the one or more processors of the vehicle processing system is further configured to make a determination regarding whether the one or more IMMs are verified. In one or more examples, the verification of the one or more IMMs includes at least decoding the one or more IMMs. The verification of the one or more IMMs also includes at least calculating a fourth checksum. The verification of the one or more IMMs further includes at least determining whether the fourth checksum value corresponds to the first checksum value.

In one or more examples, and in an instance wherein a determination is made that the one or more VMMs are verified, the one or more processors of the vehicle processing system is configured to calculate a second checksum value at operation 908. In one or more examples, the second checksum value is calculated based on a vehicle-side secret key and/or encoded data associated with the infrastructure system. As another example, the second checksum value is calculated in response to the verification of the one or more IMMs.

At operation 910, the vehicle system is configured to transmit one or more VMMs to the infrastructure system. In one or more examples, the one or more VMMs includes a third checksum value. As another example, and in one or more embodiments, the third checksum value is calculated based on the second checksum value and/or or the transformation constant.

However, in other examples, and in an instance wherein a determination is made that the one or more VMMs are not verified (e.g., at operation 906), the vehicle system is configured to transmit one or more VMMs to the infrastructure system (e.g., at operation 910) without calculating the second checksum value (e.g., at operation 908).

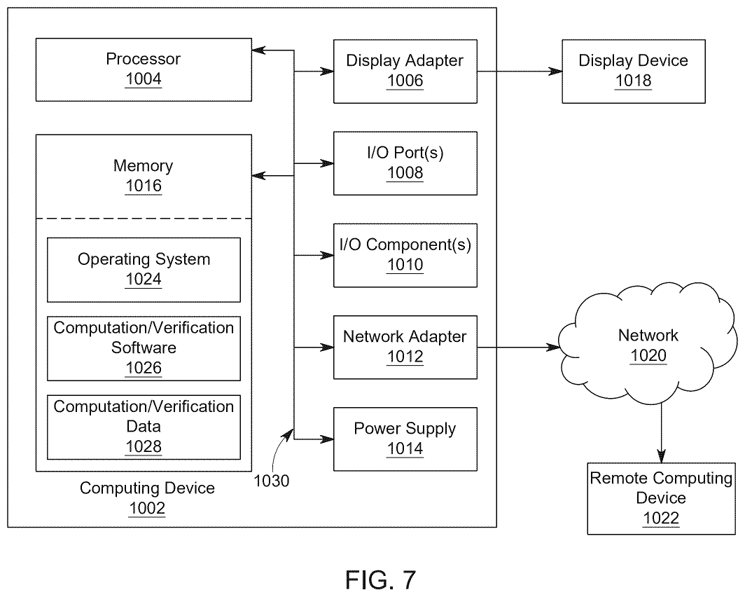

FIG. 7 illustrates an operating environment, such as a computer system, that facilitates the performance of the one or more systems and methods described herein. More specifically, the systems and methods described herein can be implemented using a computing device 1002. For example, the computing device 1002 can be a personal computer, a desktop, a laptop, a tablet, a hand-held computer, a server, a workstation, a mainframe, a wearable computer, a supercomputer, or a combination thereof. However, it is understood that the aforementioned examples of the computing device 1002 is non-exhaustive and the computing device 1002 can be any type of processing or computing device. The computing device 1002 generally includes a processor 1004, a display adapter 1006, one or more input/output port(s) 1008, one or more input/output component(s) 1010, a network adapter 1012, a power supply 1014, and a memory 1016. However, it is understood that the computing device 1002 can include any additional components therein and is not required to include any of the listed components (e.g., the processor 1004, the display adapter 1006, the one or more input/output port(s) 1008, the one or more input/output component(s) 1010, the network adapter 1012, the power supply 1014, and the memory 1016).

The processor 1004 is configured to provide instructions to the computing device 1002 so that the computing device 1002 can process one or more tasks including the implementation of a software program to perform one or more operations as described in more detail herein. It is also understood that the computing device 1002 may include any number or processors 1004 therein. The display adapter 1006 can be a graphics card or a video board that provides the computing device 1002 with a capability to display content on a display device 1018. For example, the display device 1018 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 1018 is non-exhaustive and that the display device 1018 can be any type of device capable of providing a visual display.

The input/output port(s) 1008 provide a number of interfaces (e.g., sockets) for one or more cables to connect to the computing device 1002. It is understood that there may be any number of input/output port(s) 1008 on the computing device 1002. For example, the input/output port(s) 1008 provides a means for the computing device 1002 to receive signals and/or data from an external device connected to the computing device 1002 via the one or more cables. As another example, the input/output port(s) 1008 provide a means for the computing device 1002 to send signals and/or data to an external device connected to the computing device 1002 via the one or more cables. The input/output component(s) 1010 can include one or more components that support the input/output port(s) 1008 such as, but not limited to, a switch, a push button, a pressure mat, a float switch, a keypad, a radio receive, or a combination thereof.

The network adapter 1012 can be any type of network interface controller that is configured to provide a means for communicating over a network 1020 with another computing device, such as a remote computing device 1022. For example, the remote computing device 1022 can be a user device such as a cellular-phone, a smartphone, a tablet, a laptop, or a combination thereof. The power supply 1014 is configured to convert alternating high voltage current (e.g., AC) into direct current (e.g., DC) to provide power to the other components (e.g., the processor 1004, the display adapter 1006, the one or more input/output port(s) 1008, the one or more input/output component(s) 1010, the network adapter 1012, and the memory 1016) of the computing device 1002.

Additionally, the memory 1016 can be a mass storage device and/or a system memory such as a hard disk drive, a memory card, a solid-state drive, random access memory (RAM), or a combination thereof. The memory 1016 is configured to provide storage for instructions and data associated with the operation of the computing device 1002. The memory 1016 can generally include an operating system 1024, computation/verification software 1026, and computation/verification data 1028. For example, the operating system 1024 is configured to manage and/or process any of the data and/or instructions associated with the computation/verification software 1026 and/or computation/verification data 1028, as described in more detail herein.

Furthermore, a system bus 1030 is also included within the computing device 1002 that is configured to couple each of the various components (e.g., the processor 1004, the display adapter 1006, the one or more input/output port(s) 1008, the one or more input/output component(s) 1010, the network adapter 1012, the power supply 1014, and the memory 1016) of the computing device 1002. It is also understood that each of the components of the computing device 1002, and the functionality associated with each of the components of the computing device 1002, may be implemented within the remote computing device 1022. While the operating environment illustrated within FIG. 7 depicts a particular configuration associated with at least the computing device 1002, the network 1020, and the remote computing device 1022, it is understood that the operating environment may be configured in any way.

Thus, one or more examples of the present disclosure provides a means for computing and/or verifying one or more messages exchanged between an automated vehicle and a central server, thereby providing a secure means for the exchange of the one or more messages by utilizing a checksum process as described herein.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.” In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for initiating autonomous control of an automated vehicle, the method comprising:
calculating, by one or more processors of an infrastructure system, a first checksum value based on an infrastructure-side secret key and encoded data associated with the automated vehicle located within a distance-related threshold from the infrastructure system;
transmitting, to the automated vehicle, one or more infrastructure marshaling messages that includes a second checksum value based on the first checksum value;
receiving, from the automated vehicle, one or more vehicle marshaling messages that includes a third checksum value based on a vehicle-side secret key in response to the automated vehicle verifying the one or more infrastructure marshaling messages; and
verifying the one or more vehicle marshaling messages, wherein the verification of the one or more vehicle marshaling messages includes:
decoding the one or more vehicle marshaling messages,
calculating a fourth checksum value based on the vehicle-side secret key in response to decoding the one or more vehicle marshaling messages, and
determining whether the fourth checksum value corresponds to the third checksum value.

2. The method of claim 1, wherein the calculation of the first checksum value further comprises:
transforming the infrastructure-side secret key by a transformation constant; and
appending the transformed infrastructure-side secret key to the encoded data associated with the automated vehicle.

3. The method of claim 1, further comprising:
calculating the second checksum value based on a transformation constant.

4. The method of claim 1, wherein the one or more infrastructure marshaling messages further includes the encoded data associated with the automated vehicle, a data length associated with the one or more infrastructure marshaling messages, or a combination thereof.

5. The method of claim 1, wherein the one or more vehicle marshaling messages further includes the encoded data associated with the automated vehicle, a data length associated with the one or more vehicle marshaling messages, or a combination thereof.

6. The method of claim 1, wherein decoding the one or more vehicle marshaling messages further comprises:
decoding the third checksum value;
decoding a data length associated with the one or more vehicle marshaling messages; and
decoding the encoded data associated with the automated vehicle.

7. The method of claim 6, wherein the verification of the one or more vehicle marshaling messages further comprises:
transforming the decoded third checksum value by a transformation constant;
re-computing the vehicle-side secret key based on a vehicle-side public key;
re-encoding the one or more vehicle marshaling messages; and
re-transforming the transformed third checksum value by the transformation constant.

8. The method of claim 7, wherein the calculation of the fourth checksum further comprises:
appending the re-computed vehicle-side secret key to the re-encoded one or more vehicle marshaling messages; and
transforming the re-transformed third checksum value by the transformation constant.

9. The method of claim 7, wherein the verification of the one or more vehicle marshaling messages further comprises:
determining whether a data length associated with the re-encoded one or more vehicle marshaling messages corresponds to the data length associated with the decoded data length.

10. The method of claim 1, further comprising:
establishing a communication link between the automated vehicle and the infrastructure system based on successfully determining that the fourth checksum value corresponds to the third checksum value.

11. A method for initiating autonomous control of an automated vehicle, the method comprising:
receiving, at a vehicle processing system of the automated vehicle, one or more infrastructure marshaling messages that includes a first checksum value in response to the automated vehicle being located within a distance-related threshold from an infrastructure system;
verifying the one or more infrastructure marshaling messages;
calculating, by one or more processors of the vehicle processing system, a second checksum value based on a vehicle-side secret key and encoded data associated with the infrastructure system in response to the verification of the one or more infrastructure marshaling messages;
transmitting, to the infrastructure system, one or more vehicle marshaling messages that includes a third checksum value based on the second checksum value; and
wherein the verification of the one or more infrastructure marshaling messages includes:
decoding the one or more infrastructure marshaling messages,
calculating a fourth checksum value based on the infrastructure-side secret key in response to decoding the one or more infrastructure marshaling messages, and
determining whether the fourth checksum value corresponds to the first checksum value.

12. A method of claim 11, wherein the calculation of the second checksum value further comprises:
transforming the vehicle-side secret key by a transformation constant; and
appending the transformed vehicle-side secret key to the encoded data associated with the infrastructure system.

13. A method of claim 11, further comprising:
calculating the third checksum value based on a transformation constant.

14. A method of claim 11, wherein the one or more vehicle marshaling messages further includes the encoded data associated with the automated vehicle, a data length associated with the one or more vehicle marshaling messages, or a combination thereof.

15. A method of claim 11, wherein the one or more infrastructure marshaling messages further includes the encoded data associated with the automated vehicle, a data length associated with the one or more infrastructure marshaling messages, or a combination thereof.

16. A method of claim 11, wherein decoding the one or more infrastructure marshaling messages further comprises:
decoding the first checksum value;
decoding a data length associated with the one or more infrastructure marshaling messages; and
decoding the encoded data associated with the infrastructure system.

17. A method of claim 16, wherein the verification of the one or more infrastructure marshaling messages further comprises:
transforming the decoded first checksum value by a transformation constant;
re-computing the infrastructure-side secret key based on an infrastructure-side public key;
re-encoding the one or more infrastructure marshaling messages; and
re-transforming the transformed first checksum value by the transformation constant.

18. A method of claim 17, wherein the calculation of the fourth checksum further comprises:
appending the re-computed infrastructure-side secret key to the re-encoded one or more infrastructure marshaling messages; and
transforming the re-transformed first checksum value by the transformation constant.

19. A method of claim 17, wherein the verification of the one or more infrastructure marshaling messages further comprises:
determining whether a data length associated with the re-encoded one or more infrastructure marshaling messages corresponds to a data length associated with the decoded data length.

20. A system for initiating autonomous control of an automated vehicle, the system comprising:
one or more processors of an infrastructure system configured to:
calculate a first checksum value based on an infrastructure-side secret key and encoded data associated with the automated vehicle located within a distance-related threshold from the infrastructure system,
transmit one or more infrastructure marshaling messages that includes a second checksum value based on the first checksum value,
receive one or more vehicle marshaling messages that includes a third checksum value based on a vehicle-side secret key in response to the vehicle verifying the second checksum value,
verifying the one or more vehicle marshaling messages; and
a vehicle processing system of the automated vehicle configured to:
receive the one or more infrastructure marshaling messages,
verify the one or more infrastructure marshaling messages,
calculate the third checksum value based on a vehicle-side secret key and encoded data associated with the infrastructure system in response to the verification of the one or more infrastructure marshaling messages, and
transmit the one or more vehicle marshaling messages.
